(19) United States
(12) Patent Application Publication
(10) Pub. No.: US 2009/0051303 A1
(43) Pub. Date: Feb. 26, 2009

(54) Method and apparatus for controlling movement of a device

(75) Inventor: Eric A. Holloway, West Lafayette, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/894,158

(22) Filed: Aug. 20, 2007

(51) Int. Cl. H02P 3/00

(52) U.S. Cl. 318/280; 318/434; 318/484

(57) ABSTRACT

A method of controlling movement of a device includes the steps of actuating a motor to move the device; measuring the motor current; and controlling movement of the device in response to the motor current exceeding a motor current threshold.

### TECHNICAL FIELD

The present invention relates to a method and apparatus for controlling movement o f a device, and more specifically, to a method and apparatus for controlling a motor that moves the device in response to measured motor current.

### BACKGROUND OF THE INVENTION

A known steering column assembly has tilt and telescope adjustment features. This known steering column assembly is provided with a motor which is operated by a driver of a vehicle. Operation of the motor varies the telescopic relationship between inner and outer steering column members, which varies the axial position of a steering wheel.

Also, the known steering column assembly is actuatable by the driver of the vehicle to operate a second motor. Operation of the second motor varies the tilt of an upper portion of the steering column assembly and thus varies the tilt of a steering wheel relative to the steering column assembly.

### SUMMARY OF THE INVENTION

The present invention relates to a method of controlling movement of a device comprising the steps of actuating a motor to move the device; measuring the motor current; and controlling movement of the device in response to the motor current exceeding a motor current threshold.

The present invention also relates to a method for controlling movement of a device comprising the steps of actuating a motor to move the device; measuring the motor current; calculating an average motor current; calculating a motor current threshold based on the average motor current; monitoring the motor current; and controlling the movement of the device when the monitored motor current exceeds the motor current threshold.

### BRIEF DESCRIPTION OF THE DRAWINGS

The foregoing and other features of the present invention will become apparent to one skilled in the art upon reading the following description of the present invention with reference to the accompanying drawings, wherein:

FIG. 1 is a schematic illustration of an apparatus for use in steering a vehicle;

FIG. 2 is a schematic illustration of an adjustable steering column assembly utilized in the apparatus of FIG. 1;

FIG. 3 is a schematic pictorial illustration of one embodiment of the steering column assembly of FIG. 2;

FIG. 4 is a schematic side elevational view, taken generally along the line 4-4 of FIG. 3, further illustrating the construction of the steering column assembly; and

FIG. 5 is a flow chart showing the steps for controlling the motor actuation of an actuator of the apparatus based on the motor current.

### DESCRIPTION OF PREFERRED EMBODIMENTS OF THE INVENTION

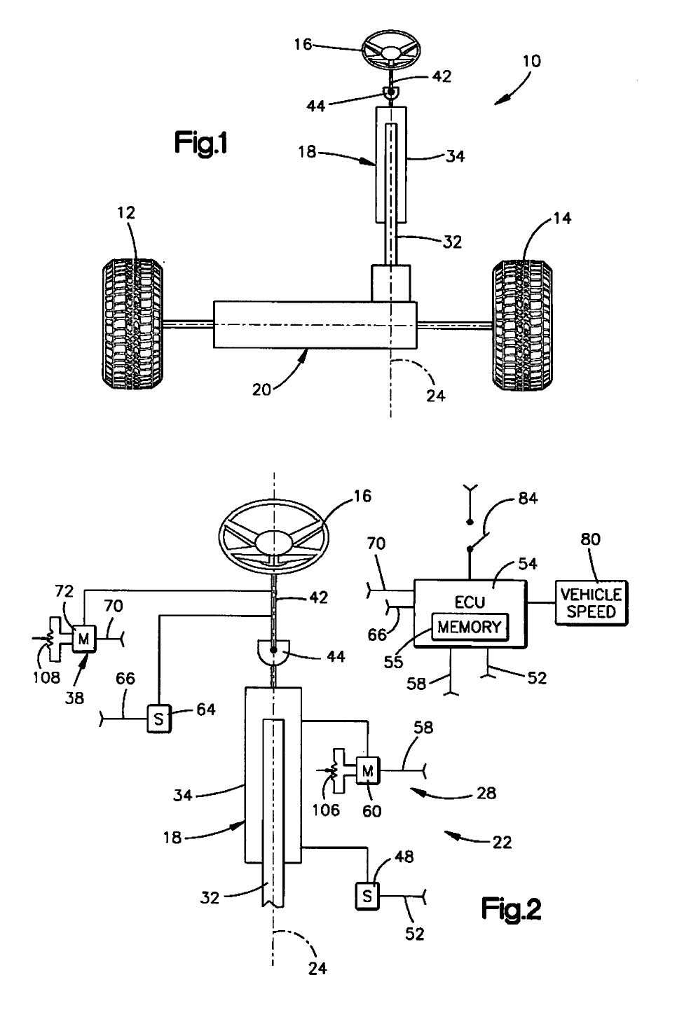

An apparatus 10 for use in turning steerable vehicle wheels 12 and 14 is illustrated in FIG. 1. The apparatus 10 includes a steering wheel 16 which is connected with an adjustable steering column assembly 18 (FIGS. 1-4). A steering gear 20 (FIG. 1) connects the steering column assembly 18 with the steerable vehicle wheels 12 and 14. The steering gear 20 is of any suitable type such as a power rack and pinion gear type. Also for example, the steering gear 20 may be a manual steering gear rather than a power steering gear. As another example, the steering gear 20 may be an integral hydraulic power steering gear or an electric motor powered steering gear.

The steering column assembly 18 includes an upper steering column member 42 pivotable about a pivot joint 44. The steering wheel 16 is connected to the upper steering column member 42. The steering column assembly 18 further includes an outer member 34 and an inner member 32 that is received by the outer member 34 in a telescoping relationship. The inner member 32 and outer member 34 may be telescoped relative to each other.

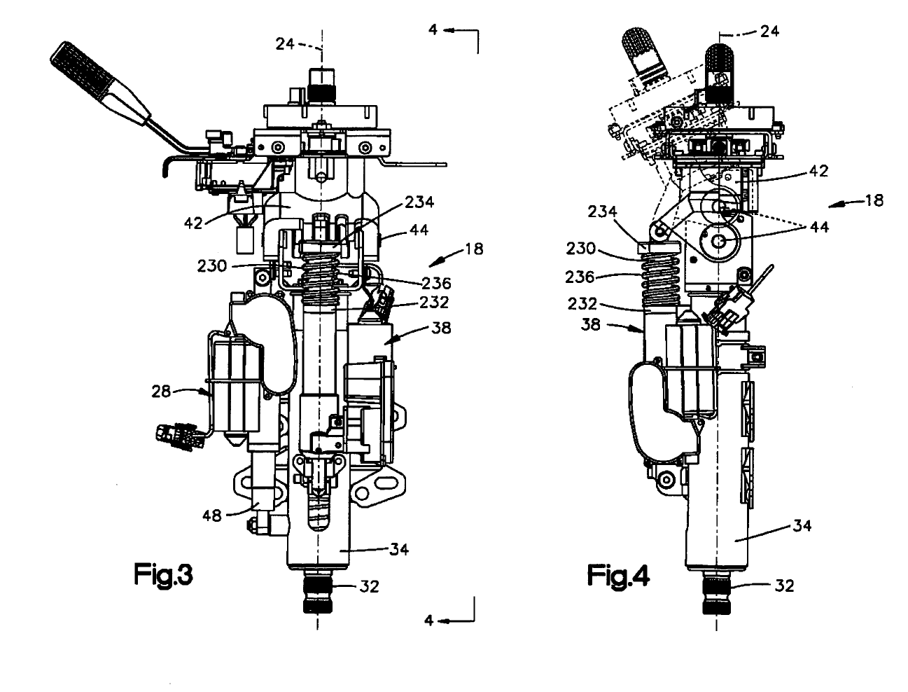

An actuating system 22 (FIG. 2) is operable to adjust the steering column assembly 18 and the position of the steering wheel 16. The actuating system 22 includes a first or telescope actuator 28 (FIGS. 2 and 3) which is operated to vary the telescopic relationship between the inner and outer members 32 and 34 of the adjustable steering column assembly 18. When a predetermined force is manually applied to the steering wheel 16 in a direction to vary the telescopic relationship between the members 32 and 3.4, the telescopic actuator 28 is operated. When the telescopic relationship between the inner and outer members 32 and 34 is to be varied, the outer member 34 and the inner member 32 are moved relative to each other by the telescopic actuator 28.

When a predetermined force is manually applied to the steering wheel 16 in a direction to tilt the steering wheel 16 relative to the central axis 24 of the steering column assembly 18, a second or tilt actuator 38 (FIGS. 2, 3 and 4) in the actuating system 22 is operated to pivot the upper steering column member 42 about the pivot joint 44. When the upper steering column member 42 is pivoted, the angular orientation of the steering wheel 16 relative to the longitudinal central axis 24 of the steering column assembly 18 is varied.

FIG. 4 illustrates first positions of the upper steering column member 42 and the outer member 34 in solid lines. Second positions of the upper steering column member 42 and the outer member 34 are shown in phantom in FIG. 4. The steering column member 42 is pivoted about the pivot joint 44 between the first and second positions and the outer member 34 is moved relative to the inner member 32 between the first and second positions. The upper steering column member 42 may have any desired number of pivot positions about the pivot joint 44 and the outer member 34 may have any desired number of positions relative to the inner member 32.

The actuators 28 and 38 may be simultaneously operated to simultaneously affect both tilt and telescopic adjustment of the steering wheel 16. Alternatively, the actuators 28 and 38 may be sequentially operated to sequentially affect tilt and telescopic adjustment of the steering wheel 16. Of course only telescopic or tilt adjustment of the steering wheel 16 may be obtained by operating only one of the actuators 28 and 38. The actuators 28, 38 may be any desired actuator.

As seen in FIG. 3, the tilt actuator 38 includes an actuator rod 230 that extends through a sleeve 232 and washer 234. Optionally, the actuator rod 230 further extends through a coil spring 236, which is positioned between the washer 232 and sleeve 234. The coil spring 236 has one end that abuts against the washer 234 and an opposite end that abuts against the end of the sleeve 232. The coil spring 236 attenuates free movement of the tilt actuator 38 caused by vibrations of the steering wheel 16.

In the embodiment of the invention illustrated in FIGS. 1-4, force is manually applied to the steering wheel 16 to vary: (1) the position of the steering wheel along the longitudinal central axis 24 of the steering column assembly 18 and/or (2) the angular orientation of the steering wheel relative to the longitudinal central axis of the steering column assembly.

When the actuators 28 and 38 are not being operated, they are effective to prevent either tilt or telescopic adjustment of the steering wheel 16. When the telescope actuator 28 is not being operated, the inner and outer members 32 and 34 are held against telescopic movement relative to each other. Similarly, when the tilt actuator 38 is not being operated, the upper steering column member 42 is held against pivotal movement at the pivot joint 44.

A rotary telescope potentiometer 106 (FIG. 2) is operatively connected to the telescope actuator 28. The telescope potentiometer 106 is adjusted by movement of the outer member 34 along the longitudinal central axis 24 of the steering column 18. Therefore, the telescope potentiometer 106 is adjusted during the movement of the steering wheel 16 in a direction either toward the operator of the vehicle or away from the operator of the vehicle. The telescope potentiometer 106 provides an output signal indicative of the telescopic position of the steering wheel 16 to the controller 54 in any desired manner.

A rotary tilt potentiometer 108 (FIG. 2) is operatively connected to the tilt actuator 38. The tilt potentiometer 108 is adjusted by the pivotal movement of the upper steering column member 42 about the pivot joint 44. Therefore, the tilt potentiometer 108 is adjusted during movement of the steering wheel 16 in a tilting direction relative to the longitudinal central axis 24 of the steering column assembly 18. The tilt potentiometer 108 provides an output signal indicative of the tilt position of the steering wheel 16 to the controller 54 in any desired manner. Other devices to determined the tilt or telescopic position of the of the steering wheel 16 could be used such as a hall effect sensor or a linear sensor.

When a driver of a vehicle wishes to change the position of the steering wheel 16 along the longitudinal central axis 24 of the steering column assembly 18, the driver manually applies a predetermined force to the steering wheel 16 (FIG. 2) to either push or pull the steering wheel. The manual application of the predetermined force to the steering wheel 16 in a direction which extends along the longitudinal central axis 24 of the steering column 18 is detected by a force sensor 48 (FIGS. 2 and 3) which is connected to the outer member 34 of the steering column 18. The force sensor 48 is a load cell which provides an output signal along a lead 52 (FIG. 2) to an electronic control unit 54.

In response to the signal from the force sensor 48, the electronic control unit 54 (FIG. 2) provides an output signal over a lead 58 to energize a reversible electric motor 60 in the telescope actuator 28. The motor 60 is then operated to effect movement of the outer member 34 along the longitudinal central axis 24 of the steering column 18. Operation of the motor 60 effects movement of the steering wheel 16 in a direction either toward the operator of the vehicle or away from the operator of the vehicle depending upon the direction of the force which is manually applied to the steering wheel 16 by the operator of the vehicle.

If the operator manually applies the predetermined force to the steering wheel 16 by pulling the steering wheel upward or toward himself, the motor 60 is operated in one direction to move the outer member 34 and steering wheel 16 upward (as viewed in FIGS. 1-4) toward the operator. Similarly, if the operator manually applies the predetermined force to the steering wheel 16 by pushing the steering wheel away from himself, the motor 60 is operated in the opposite direction to move the outer member 34 and steering wheel downward along the longitudinal central axis 24 of the steering column assembly 18.

The motor 60 in the telescope actuator 28 is a reversible electric motor. However, if desired, a reversible hydraulic or pneumatic motor may be utilized.

A force sensor 64 (FIG. 2) is provided to detect the manual application of force to the steering wheel in a direction that tilts the steering wheel 16 relative to the central axis 24 of the steering column assembly 18. The sensor 64 is connected with the upper steering column member 42 (FIGS. 2, 3 and 4). Upon manual application of force to the steering wheel 16 (FIG. 2) in a direction that tilts the steering wheel 16 relative to the central axis 24 of the steering column assembly 18, the sensor 64 provides an output over a lead 66 to the electronic control unit 54.

In response to a signal over the lead 66, the electronic control unit 54 (FIG. 2) transmits a signal over a lead 70 to energize a reversible electric motor 72 in the actuator 38. Upon operation of the motor 72, the upper steering column member 32 and steering wheel 16 are pivoted together about the connection 44 to change the angular orientation of the steering wheel 16 relative to the longitudinal central axis 24 of the steering column 18. Depending upon whether the force is applied to the steering wheel 16 in a direction toward or away from the operator, the reversible electric motor 72 is operated to either tilt the steering wheel 16 toward the operator or to tilt the steering wheel away from the operator.

The motor 72 in the tilt actuator is a reversible electric motor. However, if desired, a reversible hydraulic or pneumatic motor may be utilized.

The sensors 60 and 64 are load cells which measure force transmitted from the steering wheel 16 to a component of the steering column assembly 18. Thus, the force sensor 48 is a load cell which measures force transmitted from the steering wheel 16 to the outer member 34 of the steering column assembly in a direction along the longitudinal central axis 24 of the steering column assembly. Similarly, the force sensor 64 measures force transmitted from the steering wheel to the upper steering column member 42 in a direction that tilts the steering wheel 16 relative to the central axis 24 of the steering column assembly 18.

The load cells of the force sensors 48 and 64 contain strain gauges having an output which varies as a function of the magnitude of the force which is manually applied to the steering wheel 16.

Alternatively, the force sensors 48 and 64 may include load cells containing piezoelectric devices having output signals which vary as a function of the magnitude of the force which is manually applied to the steering wheel 16. Of course, other known force sensors may be utilized.

It is contemplated that tilt and/or telescope adjustments will be applied to the steering column assembly 18 when the vehicle is stopped. Therefore, a vehicle speed sensor 80 is connected with the electronic control unit 54. The electronic control unit 54 affects operation of one or both of the reversible electric motors 60 and 72 to adjust the position of the steering wheel 16 relative to the occupant of the vehicle only when the vehicle is stopped. If desired, a sensor which detects when a transmission of the vehicle is in park may be substituted for the speed sensor.

In order to prevent inadvertent changing of the orientation of the steering wheel 16 by an operator of a vehicle, a control switch 84 is connected with the electronic control unit 54. The control switch 84 must be actuated before the electronic control unit 54 affects operation of either the motor 60 in the telescope actuator 28 or the motor 72 in the tilt actuator 38 when the vehicle is stopped. If desired, the manually actuated control switch 84 may be omitted.

When the vehicle is being driven along the road by an operator of the vehicle, the operator may rotate the steering wheel 16 about the longitudinal central axis 24 of the steering column assembly 18 to effect turning movement of the steerable vehicle wheels 12 and 14 in a known manner. During rotation of the steering wheel to turn the steerable vehicle wheels 12 and 14, the electronic control unit 54 does not energize the electric motors 60 and 72. Therefore, telescopic and/or tilt adjustments can not be made to the steering column assembly 18 during steering of the vehicle.

When the vehicle is stopped and the control switch 84 has been actuated, the driver of the vehicle may manually apply a force to the steering wheel 16 to effect a telescopic adjustment in the steering column assembly 18, a tilt adjustment in the steering column assembly or a combination of a tilt and telescopic adjustment in the steering column assembly. The motor 60 may be energized to effect only a change in the telescopic relationship between the inner and outer members 32 and 34 of the steering column 18. Alternatively, only the motor 72 may be energized to effect pivotal movement of the upper steering column member 42 about an axis extending perpendicular to the central axis 24 of the steering column at the pivot joint 44. Alternatively, if a combination of forces is manually applied to the steering wheel 16 by the operator of the vehicle, the motor 60 may be energized to change the position of the steering wheel 16 along the axis 24 while the motor 38 is energized to change the angular orientation of the steering wheel relative to the axis 24.

It is contemplated that the inner and outer steering column members 32 and 34 and the upper steering column member 42 may be interconnected in any desired manner, such as is disclosed in U.S. Pat. No. 5,711,189. Of course, the steering column members 32, 34 and 42 may be interconnected in a manner which is different than disclosed in U.S. Pat. No. 5,711,189. The tilt and telescopic actuators 28 and 38 may be actuated in any desired manner, such as by push buttons to manually adjust the steering column assembly rather than the force sensors.

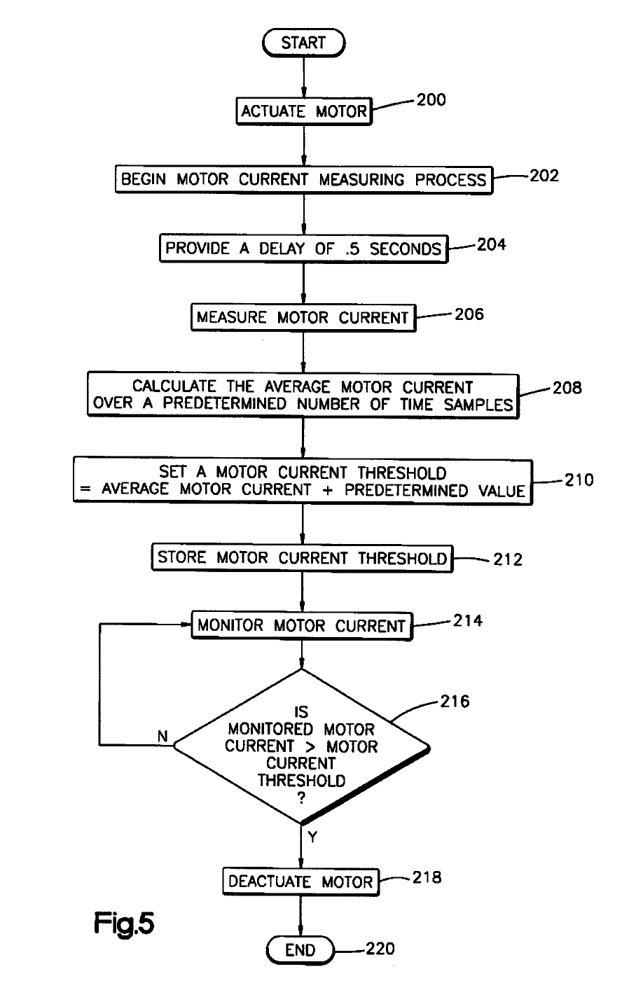

The apparatus 10 also controls the motors 60, 72 for the actuators 28, 38 based on electrical current to the motors. In general, the electronic control unit 54 electrically actuates the motors 60, 72, measures the electrical current of the motors, and controls the motors to control the movement of the steering column 18 in response to the measured current at the motors. FIG. 5 depicts the process for controlling the motors 60, 72 of the actuators 28, 38. The steps are the same for each of the actuators 28, 38, so the steps will be described in relation to the telescope actuator 28.

The process begins every time the electronic control unit 54 actuates the motor 60 of the actuator 28 as depicted in step 200 and stops when the electronic control unit 54 deactuates the motor 60. After the electronic control unit 54 actuates the motor 60, the motor current measuring process begins at step 202.

In step 204, the electronic control unit 54 delays the measuring of the current of the motor 60 for about 0.5 seconds. This delay allows the initial current spike or any other over-current transient during the delay period to be ignored by the electronic control unit 54 when measuring the current of the motor 60. The delay may be for any desired time interval.

In step 206, the electronic control unit 54 starts measuring the current of the motor 60 for a desired period of time. The electronic control unit 54 measures the current of the motor 60 by sensing the current of the motor 60 and taking time samples of the sensed current of the motor 60. In step 208, the electronic control unit 54 calculates the average motor current from the time samples. In particular, the motor current average is calculated over one hundred time samples at a rate of five milliseconds per sample. However, any desired number of samples at any desired rate per sample may be used to calculate the average motor current.

The electronic control unit 54 calculates and sets a motor current threshold in step 210. The motor current threshold is determined by adding a predetermined value stored in the memory 55 of the electronic control unit 54 to the motor current average calculated in step 208. The predetermined value may be any desired predetermined value, such as 1.5 amperes for a motor that outputs an average of 2.5 amperes of current. This motor current threshold is stored in the memory 55 in step 212. The electronic control unit 54 can include a band pass filter to determine the motor current threshold.

The electronic control unit 54 monitors the motor current in step 214. In step 216, a comparison is made by the electronic control unit 54 to determine whether the monitored motor current is greater than the motor current threshold. If the determination in step 216 is negative, the electronic control unit 54 continues to monitor the motor. If the determination in step 216 is positive, the electronic control unit 54 outputs a control signal that deactuates the motor 60 as depicted in step 218. This deactuation of the motor 60 stops the relative movement between the inner and outer members 32 and 34 and thereby stops the telescoping movement of the steering wheel 16. The process ends in step 220.

Alternatively, if the determination in step 218 is positive, the electronic control unit 54 may output a control signal that causes the motor 60 to reverse movement instead of deactuating the motor. Reversing movement of the actuator in turn reverses the telescoping movement of the steering wheel 16.

The motor current threshold is calculated to determine when the motor 60 is applying excessive force to the steering column 18. The motor 60 may apply excessive force to the steering column when the steering column engages an object that resists movement of the steering column. The electronic control unit 54 may simultaneously control both of the motors 60, 72 in a manner as discussed above.

The values for the delay time, the number of time samples and sampling rate, and the predetermined value for calculating the motor current threshold could be calibrated differently depending on the system requirements.

Further, when the coil spring 236 is provided in the tilt actuator 38, the predetermined value for calculating the motor current threshold varies based on the tilt position determined by the tilt potentiometer 108 of the steering wheel 16. Specifically, the tilt potentiometer 108 provides an output signal indicative of the tilt position of the steering wheel 16 to the controller 54, which sets the predetermined value based on the output signal.

This varying of the predetermined value is needed because the amount of compression of the coil spring 236 varies depending on the tilt position of the steering wheel 16. In particular, the more that the coil spring 236 is compressed, the more force that the coil spring exerts on the tilt actuator 38 to resist movement of the actuator rod 230. Thus, the tilt actuator 38 requires more force and hence more current by the motor 72 to move the actuator rod 230 and tilt the steering wheel 16 the more the coil spring 236 is compressed. Therefore, the predetermined value for calculating the motor current threshold of the tilt actuator 38 increases when the tilt actuator 38 tilts the steering column to a position where the coil spring 236 is compressed, so that the motor 72 of the tilt actuator 38 does not prematurely deactuate or reverse when the steering wheel 16 moves to this position.

Also, this method and apparatus for controlling a motor in response to the motor current could be used to control motors for moving windows, seats or pedals of a vehicle.

From the above description of the invention, those skilled in the art will perceive improvements, changes and modifications. Such improvements, changes and modifications within the skill of the art are intended to be covered by the appended claims. For example, analog circuitry could be used to control the motor in response to the measured motor current. Furthermore, a predetermined motor current threshold may be stored in the electronic unit 54 instead of calculating the motor current threshold each time the motor is actuated.

Having described the invention, the following is: claimed:

1. A method for controlling movement of a device comprising the steps of:
a) actuating a motor to move the device;
b) measuring the motor current;
c) calculating an average motor current;
d) calculating a motor current threshold based on the average motor current;
e) monitoring the motor current; and
f) controlling the movement of the device when the monitored motor current exceeds the motor current threshold.

2. The method of claim 1 including the step of delaying the measuring of motor current of the actuated motor for a predetermined time.

3. The method of claim 2 wherein the predetermined time of delay is sufficient to ignore an initial current transient from the motor.

4. The method of claim 1 wherein the motor is deactuated to stop movement of the device when the monitored motor current exceeds the motor current threshold.

5. The method of claim 1 wherein the motor is reversed to reverse the movement of the device when the monitored motor current exceeds the motor current threshold.

6. The method of claim 1 wherein the average motor current is calculated over a predetermined number of time samples.

7. The method of claim 1 wherein movement of the device adjusts the position of a steering wheel.

8. The method of claim 1 wherein movement of the device telescopically moves a steering wheel.

9. The method of claim 1, wherein movement of the device tilts a steering wheel.

10. The method of claim 1 including calculating the motor current threshold to be a value so that the motor is applying excessive force to the device when exceeded by the monitored motor current value.

11. The method of claim 1 including calculating the motor current threshold to be a predetermined amount above the average current.

12. The method of claim 1 wherein the motor current threshold is based upon the position of the device.

13. A method of controlling movement of a device comprising the steps of:
actuating a motor to move the device;
measuring the motor current; and
controlling movement of the device in response to the motor current exceeding a motor current threshold.

14. The method of claim 13 including the step of delaying the measuring of motor current of the actuated motor for a predetermined time.

15. The method of claim 14 wherein the predetermined time of delay is sufficient to ignore an initial current transient from the motor.

16. The method of claim 13 wherein the motor is deactuated to stop movement of the device when the motor current exceeds the motor current threshold.

17. The method of claim 13 wherein the motor is reversed to reverse the movement of the device when the motor current exceeds the motor current threshold.

18. The method of claim 13 wherein movement of the device adjusts the position of a steering wheel.

19. The method of claim 13 wherein movement of the device telescopically moves a steering wheel.

20. The method of claim 13, wherein movement of the device tilts a steering wheel.

21. The method of claim 13 including calculating the motor current threshold to be a value so that the motor is applying excessive force to the device when exceeded by the motor current value.

22. The method of claim 13 including calculating the motor current threshold to be a predetermined amount above the average current.

23. The method of claim 13 wherein the motor current threshold is based upon the position of the device.
